(19) United States
(12) Patent Application Publication
(10) Pub. No.: US 2018/0012509 A1
(43) Pub. Date: Jan. 11, 2018

(54) BEHAVIOUR MODIFICATION

(71) Applicant: CAN-DO CORPORATION LIMITED, London (GB)

(72) Inventor: John Rose, London (GB)

(21) Appl. No.: 15/641,905

(22) Filed: Jul. 5, 2017

(30) Foreign Application Priority Data
Jul. 5, 2016 (GB) 1611699.8

(51) Int. Cl. G09B 19/00; G09B 5/06; G09B 5/04

(52) U.S. Cl. CPC G09B 19/0007; H04B 1/3833; G09B 5/04; G09B 5/06

(57) ABSTRACT

An apparatus comprises training means to provide training with respect to behavior modification, stimulus means to provide an association with the training means, and stimulus generating means to generate a stimulus post presentation of the training means. The stimulus generating means has a plurality of potential different stimuli types with at least two stimuli in time-spaced-apart relationship to each other to create a distinct trigger as a stimulus phrase for an individual to recall the training or therapy. The stimulus generating means makes available a number of stimulus phrases to an individual user for different environments expected by an individual user so one stimulus phrase is adopted by an individual user as their distinct trigger in an environment expected by the user. The stimulus means is arranged to provide at least a part of the distinct trigger during association with the training sufficient for recall of the training or therapy.

### TECHNICAL FIELD

The present invention relates to behavior modification and the like in human subjects and particularly but not exclusively to such modification with respect to encouragement and reinforcement of lifestyle and performance enhancement.

### BACKGROUND

It is known to combine performance enhancement and lifestyle improvement training with physical anchors such as audible noises or vibration such that as required an individual is prompted to recall their earlier training in order to avoid temptation, or deviate from the desired behavior, or simply to provide cyclic recall of that behavior for reinforcement or progressive reinforcement. International patent application no. PCT/GB97/01898 and UK Patent no. 2370233 both illustrate such approaches to behavior modification. In short, the process can be considered as the use of an external stimulus to trigger previously learnt appropriate responses to suggestions, actions and other stimuli. Thus, for example, a smoker trying to quit could undertake a self-help course, and the positive message would become associated with an external stimulus such that during cravings the stimulus can be repeated helping the smoker to recall the positive reasons for not smoking and, or, the negative reasons for continuing smoking.

### SUMMARY

It will be understood that the processes for training or therapy are generally well thought out by qualified individuals in order to provide the necessary aversion, or yearning for a healthy lifestyle, or other training such as described above with respect to stopping smoking. Throughout the therapy a signal demand to operate the regime must be generated whereby the user then subconsciously associates the stimulus with the particular training or therapy and the positive results gained from it. This generation of the stimulus may be automatic, or specifically induced by the user, in order to, as indicated, either repetitively reinforce the training or therapy or to enhance a recall of that training or therapy, and its potential gains, during times of craving or weakness. Clearly, the combination of therapy/training and stimulus will be chosen by the therapist and user in order to achieve the best response. As indicated, the association between the training and stimulus may be automatic, manual or determined through some control feedback mechanism such as the individual's breathing, temperature or heart rate. Furthermore, it will be appreciated that during early stages of the training or therapy the number of stimuli provided as a trigger to recall the training or therapy regime will tend to be more regular and frequent than towards the end of the therapy or training period when stimuli may be manually activated by the user, when required.

Clearly, the number of stimuli available is limited. Furthermore, these stimuli must be distinct. If the stimulus was a simple buzzer it will be understood that the individual may, on every occasion they hear a doorbell, be caused to recall the training. In certain circumstances this may be beneficial, but in others may, if experienced by the user, as a polluting background chatter lead to detrimental subconsciousness desensitizing. Previous techniques to avoid these problems have included use of normal CD players and hand fobs such that the signal can be generated outside the normal human audio range but still be acceptable for recall of the training or therapy and its potential gains. The stimulus may be recorded as a discreet but hidden element within a specific jingle or music played through conventional CD equipment or otherwise. Understandably, users may not want to wear their headphones or other equipment all the time, so there may be a time delay between the stimulus required and the actual provision of that stimulus to the individual to recall the training or therapy, and its potential gains. One alternative is to provide built-in means within a conventional device in order to provide the stimulus. Thus, a watch could incorporate a vibration device to enable an individual to receive a desired stimulus through that device, whilst for the remainder of the time the watch operates as per normal. Ideally more individual specific means for providing the stimulus are desirable.

According to a first aspect of the present invention there is provided an apparatus for behavior modification comprising training means to provide training with respect to behavior modification, stimulus means to provide an association with the training means and stimulus generating means to generate a stimulus post presentation of the training means, the stimulus generating means having a plurality of potential different stimuli types with at least two stimuli in time-spaced-apart relationship to each other to create a distinct trigger as a stimulus phrase for an individual to recall the training or therapy, the at least two stimuli taken from the plurality of stimuli types within the stimulus generating means, the stimulus generating means making available a number of stimulus phrases to an individual user for different environments expected by an individual user so one stimulus phrase is adopted by an individual user as their distinct trigger in an environment expected by the individual user, the stimulus means arranged to provide at least a part of the distinct trigger during association with the training sufficient for recall of the training or therapy, wherein a one of the stimuli is a personalized audio message with unique content.

Possibly, the personalized audio message is provided by an individual user of the apparatus, a therapist or a trainer. Possibly, the personalized audio message is recorded directly onto the individual user's device or devices, such as a mobile phone or tablet computer, or recorded on an external site and subsequently accessed remotely by the individual user. Possibly, additional personalized audio messages with different unique content could be recorded remotely by the therapist or trainer and made available to the individual user. Possibly, the additional personalized audio messages could replace any existing personalized audio messages, or be provided as alternatives thereto.

Possibly, the personalized audio message has a duration of around one minute. Possibly, the other of the stimuli utilized in the stimulus phrase is any of auditory, visual, tactile, olfactory or gustatory, i.e. anything which reacts with one or several human senses.

Typically, the apparatus allows an individual user to choose his or her own stimulus phrase. Generally, more than one stimulus phrase may be provided for respective parts of the training or therapy. Generally, the training or therapy comprises a plurality of lessons, and each lesson has its own stimulus phrase. Normally, the stimulus generating means comprises time means to periodically provide the stimulus phrase. Advantageously, the stimulus generating means comprises manual means to produce the stimulus phrase manually when a user so requires. Typically, the stimulus generating means comprises means to sense a condition within an individual user in order to determine when to provide the stimulus phrase.

According to a second aspect of the present invention there is provided a method of behavior modification, the method including providing training means to provide training with respect to behavior modification, stimulus means to provide an association with the training means and stimulus generating means to generate a stimulus post presentation of the training means, the stimulus generating means having a plurality of potential different stimuli types with at least two stimuli in time-spaced-apart relationship to each other to create a distinct trigger as a stimulus phrase for an individual to recall the training or therapy, the at least two stimuli taken from the plurality of stimuli types within the stimulus generating means, the stimulus generating means making available a number of stimulus phrases to an individual user for different environments expected by an individual user so one stimulus phrase is adopted by an individual user as their distinct trigger in an environment expected by the individual user, the stimulus means arranged to provide at least a part of the distinct trigger during association with the training sufficient for recall of the training or therapy, wherein a one of the stimuli is a personalized audio message with unique content.

Possibly, the apparatus includes any of the features described in any of the preceding statements or following description. Possibly, the method includes any of the steps described in any of the preceding statements or following description.

### BRIEF DESCRIPTION OF THE DRAWINGS

Embodiments of the present invention will now be described by way of example only, and with reference to the accompanying drawings, in which:

FIG. 1 is a schematic illustration of a first behavior modification system;

FIG. 2 is a schematic illustration of a second behavior modification system;

FIG. 3 is a schematic illustration of a third behavior modification system; and,

FIG. 4 is a schematic illustration of a fourth behavior modification system.

### DETAILED DESCRIPTION

As indicated above a system is known to provide a combination of training or therapy in order to provide for behavior modification and/or performance improvement. These behavior modifications and performance improvements may relate to giving up smoking or dieting or possibly an improved golf swing. Essentially an association process is used whereby achievement of the desired behavior modification or lifestyle improvement is marked by the stimulus in a unique manner such that the individual receiving the training or therapy will then associate that modification or improvement with the particular stimulus. As indicated above, UK patent no. 2370233 and International patent application no. PCT/GB97/01898 provide examples of previous approaches to therapy and training for behavior modification and performance improvement.

People lead busy lives and therefore require any reminiscent stimuli in the most convenient manner possible. In many circumstances the general noise background may pollute the perceptiveness of the stimulus, and in any event it will be understood that in public places it will be desirable to provide the individual with the stimulus without disturbing neighbors both generally, and, with respect to those neighbors providing stimuli for their own therapy and training regimes which are possibly being undertaken by them. Alternatively, in some circumstances it may be desirable to provide a stimulus to a whole group such as those undergoing stress management when situations of stress are detected, e.g. an emergency operations room during the middle of a crisis.

Clearly, the stimulus can be anything that reacts with one or several human senses in order that the stimulus is noticeable to that human individual. It is originality that provides the basis in accordance with the principles of the present invention for achieving acceptable operation of an apparatus incorporating association with a stimulus. What is necessary is provision of a substantially distinct stimulus phrase to the user. This stimulus phrase can be formed from a single stimulus, provided it is unique, but is more normally a combination of two or more stimuli.

A single stimulus may take the form of a unique noise or a scent appropriately presented to that individual. A noise may be a peculiar musical note form or sound. Thus, for example, an exotic animal call, untypical in the locality of the individual, may be used. Alternatively, a peculiar smell may be presented to the individual, specifically directed towards their nose, or any other humanly perceptible stimulus may be used including a tactile one, e.g. a pin prick or electrical charge may be used. Nevertheless, it will be understood that acceptable single stimuli may be difficult to find, such that there is a unique distinctiveness for a particular training regime or therapy identifiable to the individual as well as clearly separable from environmental background noise, and non-intrusive with respect to the individual's neighbors.

Normally, two or more stimuli are combined in order to provide a stimulus phrase. These stimuli may be of the same type or a combination of different stimuli. Furthermore, the stimuli may be presented at distinct time spacings to add further uniqueness with respect to the stimulus phrase or arranged to fully or partially overlap each other in order to create a unique or readily distinctive stimulus phrase for association with the training or therapy, in accordance with the desired behavior modification.

Stimuli of the same type used to form the stimulus phrase may be a noise, or a combination of chemicals, to produce a unique scent. Thus, for example, a first noise may be followed in a time span of two seconds by a second noise such that a unique combination is therefore provided which is more distinguishable from the environmental background noise. A similar approach can be taken with regard to picking up a signal within a broadcast or played recording during a training regime, or therapy lesson or session. In such circumstances a device looks for a complete signal cycle in a broadcast or recording in order to create the necessary stimulus phrase. If the device hears part of a signal it will then listen to receive the remainder of the signal before providing the stimulus. In such circumstances a broadcast device will repeat the signal to stimulate the means for generating the stimulus phrase repeatedly until received by the means for generating the stimulus, and in any event, increasing the chances of the means for generating the stimulus receiving the necessary signal despite background noises. It will also be understood by an interaction between the broadcast device and the means for generating the stimulus signal to the user that, a form of calibration with respect to the background noise can be achieved. Alternatively, it is possible to listen for silences rather than noise within a training program in order to reduce the need for sophisticated electronics or high quality microphones and associated equipment. Nevertheless, means for identifying the stimulus within the recorded message if that is used as a means by which the training or therapy is undertaken by the individual can either simply be a trigger within that recorded message in order to cause some other device to provide a different or additional stimulus to the individual or itself be of a stimulus form recalled by the individual if a noise or a noise combination. In any event it is providing a stimulus phrase of some form whereby it can be recognized by an individual, which is a principal requirement.

It is important to ensure a signal is received even in difficult environmental conditions. It will be appreciated if a signal for a stimulus (characterized jingle) is received and then the secondary stimulus (scent) is not received then essentially there is a break in the user recognition or connection with the underlying therapy or training. Thus, it is advisable to use back up or feedback techniques to ensure all elements of the stimulus phrase are received. A control system may look for any two trigger signals whereby if it picks up part of a signal it will trigger the stimulus phrase if it receives another part of the trigger signal in the next few seconds. In such circumstances, it is not necessary to receive a full trigger signal but just distinct parts of trigger signals. In such circumstances, it is possible to transmit several trigger signals one after the other and the system only has to pick up partial signals to operate the stimulus phrase, but by looking for multiple signals is unlikely to operate accidentally. As an alternative to using feedback, it is possible if a receiver thinks it hears a trigger signal it can then interrogate a source of the trigger signals in order to stimulate an appropriate reply response within a certain time in order to confirm and trigger operation and release of the stimulus phrase. Thus, for example, if a device for emitting the stimulus phrase were to receive a number of partial signals but receive no confirmatory reply response then it may be suggested that the user find a quieter situation where the trigger signals can be more readily received or moved closer to the source of the trigger signals.

The stimulus phrase must have some originality. Thus, as indicated, two audible signals in a time spaced relationship or a sound and a scent combined again in a spaced relationship may provide the necessary stimulus phrase to enable a user to recall previous training or therapy lessons or events, or the potential gains thereof. Furthermore, by providing two stimulus signals there is a degree of back up if one fails, e.g. the wind blows the scent signal away from the user. Furthermore, subconsciously there is a trigger by first using a noise or light signal, which causes the user to inhale more deeply, thus optimizing the stimulus effects of a scent.

As an alternative, a combination of stimuli, either fully overlaying or partially overlapping each other, may be used in order to provide the stimulus phrase. In such circumstances a noise may be combined with a slightly preceding, simultaneous, or slightly delayed, release of a scent stimulus. The audible noise will reinforce the expectation of receiving the sense stimulus, or vice versa, so further triggering greater association with the training or therapy regime. It will also be understood that two odors may be mixed in order to create an optimized scent stimulus phrase for better, environmentally distinct, stimulus to the individual for association with the training or therapy lesson or potential gains thereof.

In any event, the stimulus phrase should create a clear association with the training or therapy or the potential gains thereof. It should also be understood to provide distinct stimulus, with the action of the stimulus phrase being transient and momentary to the user, such that it does not linger and become a general scent pollution or continuous stimulus to the user. Finally, the stimulus phrase should be distinct and unmistakable such that no confusing memories or associations are activated.

The present apparatus has particular applicability to a wide range of therapy and training regimes. The fixing of the association between the training regime and the stimulus phrase is essential in order to provide the continuing ongoing reinforcement of the regime. The present invention has particular applicability with respect to so called self-help training or therapy regimes, wherein a CD or training booklet is provided for home study by an individual. Nevertheless, a therapist or trainer may through use of a manually operated stimulator, during the course of a training or therapy session, achieve association within an individual or a group of individuals with respect to that particular part of the session. In any event, a training session incorporating stimulus phrase association will be followed by a period during which the stimulus phrase alone is provided at appropriate times. As indicated previously, the manner in which the stimulus phrase is provided to the individual will be dependent upon particular environmental conditions. However, the actual timing of such stimulus phrase action will be adjusted in accordance with particular individuals' requirements. Thus, a user may receive some help from a trainer or therapist and then be left with literature and a CD for further reinforcement of the training or therapy. The stimulus phrase may be provided by playing a CD. The CD may stimulate, or through simple time of spacing, or manual initiation, or through sensing a particular status within the individual, e.g. anxiety through heart beat or blood pressure, breathing rate or temperature as required, offer the individual further reinforcement of the therapy or training.

By providing an individual with environmentally distinct stimulus phrase it will be appreciated that the present apparatus allows a greater degree of interactivity for the particular individual. Thus, within a group training or therapy session it will be appreciated that different people will learn or react differently. Furthermore, a group of people may not all work or socialize together or not even within a family, or live together, such that use of a common stimulus phrase for all members of that group may be inconvenient. By creating a degree of uniqueness with respect to the stimulus phrase in accordance with the present invention, each individual may receive the stimulus phrase in a distinct manner from other members of the group when and as required. In such circumstances, a stimulus phrase for the group may be defined, and then an individual stimulus phrase be provided for each individual member of that group, whereby, selectively, the whole group can be reminded as to the training or therapy or the potential gains or individual members of that group or subgroups appropriately reminded.

The apparatus, in accordance with the present invention to provide for behavior modification, may incorporate both passive as well as active forms of training or therapy. As indicated, apart from use by an actual trainer or therapist the present apparatus is particularly applicable to so called self-help learning techniques. These self-help learning techniques generally comprise a recorded program, listing actions, as well as supporting literature. In a passive regime this recording is a monologue with respect to reciting the training or therapy with, normally, reference to the literature and, in accordance with the present invention, emission of the appropriate stimulus phrase at the various stages throughout the recording in order to provide a more physiological anchor, reminiscent of particular passages or statements within the training regime. In such circumstances the initial training or therapy stages are anchored at fixed points by the emission of the stimulus phrase and then subsequently recalled as indicated previously by a device such as headphones or means for emitting a scent or otherwise at appropriate stages in order to remind the individual as to their training or therapy regime.

In an active training or therapy regime generally a computer program is provided through which the participant individual undergoes the regime with a degree of interaction with the apparatus or trainer. Therefore, the actual positioning of the stimulus phrases within the training regime may be adjusted dependent upon the interaction with the individual, that is to say to responses by that individual to questions or other situations within the training or therapy regime. Nevertheless, these stimulus phrases still, as indicated previously will be configured to be distinct to an individual or closely defined group, and so, in accordance with the regime, provide an association for greater recall and enforcement of the therapy/training with that individual.

Additionally, with regard to an active training or therapy regime in accordance with self-help principles, it will be understood that the individuals themselves may choose between different forms of stimuli thus creating their own distinct stimulus phrases for the training or therapy regime. By such an approach the individual may pick a particular stimulus phrase most appropriate for that individual's environment and expectations.

It will be appreciated that the stimuli utilized with respect to the present invention can be delivered in a number of systems. The drawings illustrate four exemplary systems but others may be used.

FIG. 1 illustrates a first manual, behavior modification system in which a stimulation device 4 is activated by a fob 2 which emits an RF signal 3 when a fob 2 button is pressed. The RF signal 3 is picked up by the device 4.

A therapist or trainer 1 speaks directly to a user 5. When it is time to activate the secondary stimulation, in this case the device 4 the fob 2 is manually activated and a signal 3 is transmitted. Alternatively, the system may be a self-help regime where a CD message is played with prompts to manually activate the fob 2.

The signal 3 can take many forms including radio waves, infrared or sound. Of note is a similar scenario where the trainer is communicating by a phone or similar and the signal is transmitted also via a phone network.

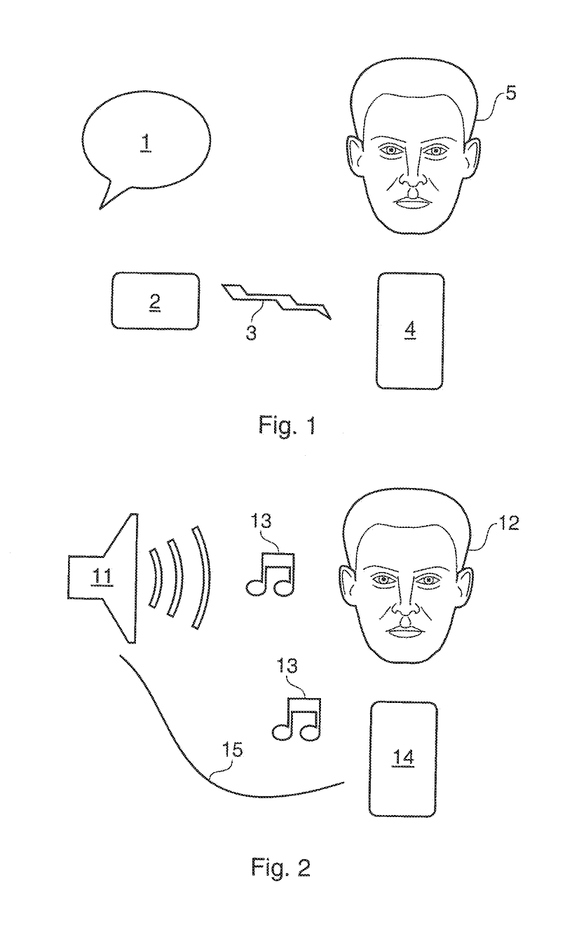

FIG. 2 illustrates a second, audio, behavior modification system in accordance with a standard player device such as a CD player 11, broadcasts a lesson. Within this lesson there is a trigger signal 13 which could be in the form of a jingle, which is heard by a user 12.

Similarly, this trigger signal 13 can be ‘heard’ by the stimulator device 14, or by a device such as a fob (see FIG. 1). This will cause the device 14 to activate (in the case of a fob via RF). Alternatively, a wire 15 could run from the output socket on the CD player 11. This would reduce the effects of environmental pollution, passing the signal to headphones on the user and/or directly to the device 14 or a trigger device (fob).

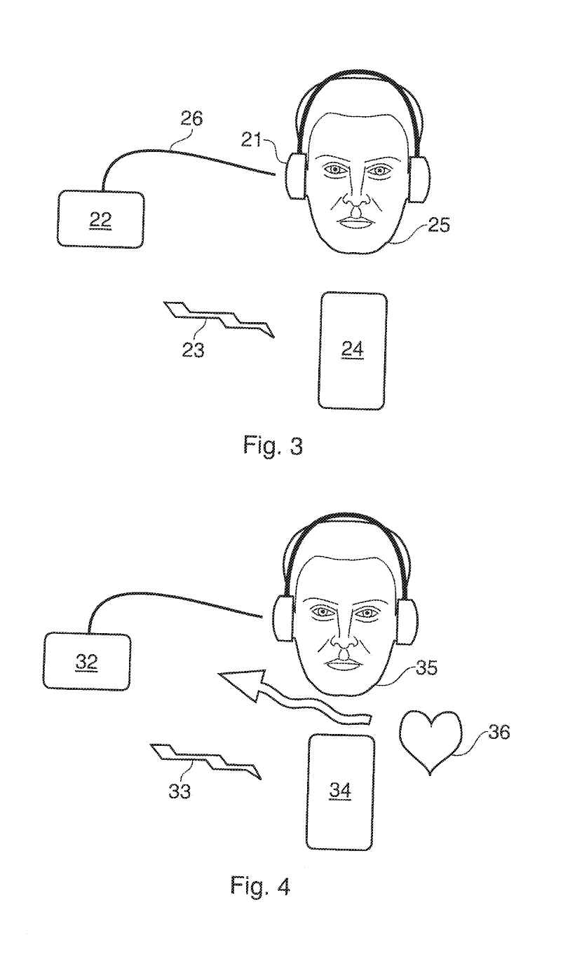

FIG. 3 illustrates a third integral behavior modification system in accordance with the present invention. A player device 22 contains the means for playing a recorded message.

A user 25 could wear headphones 21. The player device 22 replaces a CD player and the fob from the systems above. The device 22 could be an MP3 player or any similar device that can store and broadcast sound/vision information to the user 25. However, at the appropriate parts in the broadcast message the device 22 transmits a signal 23 to a stimulator device 24. Again, this signal 23 can take many forms, including a radio frequency. The device 22 is also likely to have a manual operation button, enabling it to be used like a simple fob (see FIG. 1).

It is also of note that the player device 22 could be a home PC or any electrical device capable of being programmed and sending a signal. This includes modern mobile phones. Finally, the headphones 21 could be coupled to the player device 22 by a fixed wire 26 or any wireless link.

FIG. 4 illustrates a fourth, feedback behavior modification system in accordance with the present invention. A connection, whether wire or wireless between a fob 32 and the stimulator device 34 is two-way. Thus, bodily information from a user 35 can be transmitted back to the fob 32 and the message playing modes (speed/repetition etc.) can be adjusted as necessary and a signal 33 to activate the stimulus device 34 adjusted accordingly.

A secondary device 36, such as a heartbeat or body temperature sensor monitors environmental or user attributes and feeds these back to the fob 32 as a control device. In this example the user's heart rate is broadcast and the stimulus phrase adjusted accordingly.

As indicated above, the present invention is based upon creating environmentally distinct stimulus phrases. Thus, these phrases may combine an audio or visual stimulation created by a radio, TV, mobile phone, terrestrial phone, computer or player for cassette tapes, CD, MP3 or other programmable recall apparatus along with stimuli created by vibrators or olfactory stimulators, lights, crystals or temperature or otherwise. Communication between all parts of the equipment to create the distinct stimuli, in sequence, and so create the stimulus phrase may be hard wired together or by use of wireless technology, such as radio frequency communication, or Blue Tooth, or infrared, or ultrasonic, or other means of coordinating stimuli emissions to a user.

In examples of the current disclosure, a one of the stimuli of a stimulus phrase including at least two stimuli is a personalized audio message with unique content.

The personalized audio message could be provided by an individual user of the apparatus, a therapist or a trainer. The personalized audio message is unique to the individual user, and could include any content. The unique content may be associated with the content of a therapy or training session the individual user has attended. The unique content could encourage a user, for instance, to be mindful, or to focus on one or more positive outcomes. The personalized audio message may have any duration, but preferably has a duration of around one minute.

The personalized audio message reinforces the other stimuli of the stimulus phrase, and therefore provides an overall more effective stimulus phrase. The personalized audio message has been demonstrated to increase an individual user's personal motivation to achieve a behavior modification and/or performance improvement, such as stopping smoking.

The personalized audio message reduces the requirement for an individual to attend therapy or training sessions, and the associated costs and inconvenience, because the trainer or therapist provides unique personalized audio messages to complement or replace therapy or training sessions. This leads to a user feeling more directly in touch with the therapist or trainer, and provides a high level of interaction between the user and therapist or trainer.

The personalized audio message could be recorded directly onto a user's device or devices, such as a mobile phone or tablet computer. Alternatively, or additionally, the personalized audio message could be recorded on an external site using an internet connection and subsequently accessed remotely by the individual user over the internet. The user could download the personalized audio message from the external site to a personal device or devices.

Furthermore, additional personalized audio messages with different unique content could be recorded remotely by the therapist or trainer and made available to the individual user. These additional personalized audio messages could replace any existing personalized audio messages, or be provided as alternatives thereto.

The additional personalized audio messages could also be accessed remotely by the user over the internet, and if required, downloaded to a user's own personal device or devices.

Advantageously, once the personalized audio messages are on a user's device or devices, the personalized audio messages are always available to the user irrespective of the time of day, the location of the user, or the availability of an internet connection.

Features described in the preceding description may be used in combinations other than the combinations explicitly described.

Although functions have been described with reference to certain features, those functions may be performable by other features whether described or not.

Although features have been described with reference to certain examples, those features may also be present in other examples whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

What is claimed is:

1. An apparatus for behavior modification, comprising:
training means to provide training with respect to behavior modification;
stimulus means to provide an association with the training means; and
stimulus generating means to generate a stimulus post presentation of the training means,
the stimulus generating means having a plurality of potential different stimuli types with at least two stimuli in time-spaced-apart relationship to each other to create a distinct trigger as a stimulus phrase for an individual to recall the training or a therapy, the at least two stimuli taken from the plurality of potentially different stimuli types within the stimulus generating means, the stimulus generating means making available a number of stimulus phrases to an individual user for different environments expected by an individual user so one stimulus phrase is adopted by an individual user as their distinct trigger in an environment expected by the individual user, the stimulus means arranged to provide at least a part of the distinct trigger during association with the training sufficient for recall of the training or the therapy, wherein one of the at least two stimuli is a personalized audio message with unique content.

2. The apparatus of claim 1, wherein the personalized audio message is provided by an individual user of the apparatus, a therapist, or a trainer.

3. The apparatus of claim 1, wherein the personalized audio message is recorded directly onto one or more devices of the individual user, the one or more devices including a mobile phone or tablet computer.

4. The apparatus of claim 1, wherein the personalized audio message is recorded on an external site and subsequently accessed remotely by the individual user.

5. The apparatus of claim 1, wherein additional personalized audio messages with different unique content are recorded remotely by a therapist or a trainer and made available to the individual user.

6. The apparatus of claim 5, wherein the additional personalized audio messages is to replace any existing personalized audio messages, or be provided as alternatives thereto.

7. The apparatus of claim 1, wherein the other of the at least two stimuli utilized in the stimulus phrase is at least one of an auditory, visual, tactile, olfactory, or gustatory stimulus, or another stimulus that reacts with one or several human senses.

8. The apparatus of claim 1, wherein the apparatus allows an individual user to choose his or her own stimulus phrase.

9. The apparatus of claim 1, wherein more than one stimulus phrase is provided for respective parts of the training or the therapy.

10. The apparatus of claim 1, wherein the training or the therapy comprises a plurality of lessons, and wherein each lesson of the plurality of lessons has a corresponding stimulus phrase.

11. The apparatus of claim 1, in which the stimulus generating means comprises time means to periodically provide the stimulus phrase.

12. The apparatus of claim 1, in which the stimulus generating means comprises manual means to produce the stimulus phrase manually when a user so requires.

13. The apparatus of claim 1, in which the stimulus generating means comprises means to sense a condition within an individual user in order to determine when to provide the stimulus phrase.

14. A method of behavior modification, the method including:
providing a training component to provide training with respect to behavior modification;
providing a stimulus component to provide an association with the training component; and
providing a stimulus generating component to generate a stimulus post presentation of the training component, the stimulus generating component having a plurality of potential different stimuli types with at least two stimuli in time-spaced-apart relationship to each other to create a distinct trigger as a stimulus phrase for an individual to recall the training or a therapy, the at least two stimuli taken from the plurality of potentially different stimuli types within the stimulus generating component, the stimulus generating component making available a number of stimulus phrases to an individual user for different environments expected by an individual user so one stimulus phrase is adopted by an individual user as their distinct trigger in an environment expected by the individual user, the stimulus component arranged to provide at least a part of the distinct trigger during association with the training sufficient for recall of the training or the therapy, wherein at least one stimulus is a personalized audio message with unique content.

15. The method of claim 14, wherein the personalized audio message is provided by the individual user, a therapist, or a trainer.

16. The method of claim 14, wherein the personalized audio message is recorded directly onto one or more devices of the individual user, such as a mobile phone or tablet computer.

17. The method of claim 14, wherein the personalized audio message is recorded on an external site and subsequently accessed remotely by the individual user.

18. The method of claim 14, wherein additional personalized audio messages with different unique content could be recorded remotely by a therapist or a trainer and made available to the individual user.

19. The method of claim 18, wherein the additional personalized audio messages is to replace any existing personalized audio messages, or be provided as alternatives thereto.

20. The method of claim 14, wherein the personalized audio message has a duration of one minute or substantially one minute.
